(19) United States
(12) Patent Application Publication
(10) Pub. No.: US 2019/0148706 A1
(43) Pub. Date: May 16, 2019

(54) ACCUMULATOR MODULE

(71) Applicant: YAMAHA HATSUDOKI KABUSHIKI KAISHA, Iwata-shi (JP)

(72) Inventor: Noriyuki OHNISHI, Iwata-shi (JP)

(73) Assignee: YAMAHA HATSUDOKI KABUSHIKI KAISHA, Iwata-shi (JP)

(21) Appl. No.: 16/200,217

(22) Filed: Nov. 26, 2018

Related U.S. Application Data
(63) Continuation-in-part of application No. PCT/JP2016/084479, filed on Nov. 21, 2016.

(30) Foreign Application Priority Data
May 26, 2016 (JP) 2016-104967

(51) Int. Cl. H01M 2/26; B23K 20/10; H01M 10/05; H01M 10/42; H01M 2/30

(52) U.S. Cl. CPC H01M 2/266; B23K 20/10; H01M 2/30; H01M 10/4207; H01M 10/05

(57) ABSTRACT

An accumulator module includes at least two stacked accumulator cell bodies and an aluminium positive electrode terminal that protrudes, without forming a step, from inside of one accumulator cell body in a direction crossing a stacking direction. A high-hardness negative electrode terminal has an overlap with the aluminium positive electrode terminal when viewed in the stacking direction and protrudes, without forming any step, from inside of an overlaid accumulator cell body. The accumulator module includes an ultrasonic pressure-welded portion formed by welding the aluminium positive electrode terminal and the high-hardness negative electrode terminal to each other in a region overlapping at least one ultrasonic pressure-welding horn impression when viewed in the stacking direction.

### TECHNICAL FIELD

The present teaching relates to an accumulator module.

### BACKGROUND ART

Recently, there is a push to use a motor as a power source of a vehicle. This gives rise to a need for the technical development of an accumulator module which supplies electric power to the motor.

It is desired that a vehicle be equipped with an accumulator module that has good vibration resistance and good heat dissipation properties and that is capable of accumulating a large amount of electric power. Recently developed is a battery pack serving as a battery module including a plurality of flat-type cells connected in series. Driving a vehicle or the like requires a large amount of energy. To address the requirement, the cell tends to increase in size.

Examples of the accumulator module include a lithium-ion battery module. In such an accumulator module, a cell includes a positive electrode tab and a negative electrode tab. The positive electrode tab and the negative electrode tab of the cell are ultrasonically bonded. Thus, a plurality of cells are connected in series.

For example, Patent Literature 1 (PTL 1) proposes a technique relating to an ultrasonic bonding structure.

### CITATION LIST

### Patent Literature

PTL 1: Japanese Patent No. 4946098

### SUMMARY OF INVENTION

### Technical Problem

In a battery pack including a plurality of cells connected in series, as described above, each cell tends to increase in size. This makes it likely that an electrode tab of the battery pack mounted on a vehicle receives large vibration when the vehicle is vibrated at a time of, for example, traveling on a rough road. The battery pack is required to have a reliable bonding strength of electrode tabs capable of withstanding vibration.

In a step of assembling the battery pack, to ultrasonically bond an electrode tab of one cell to an electrode tab of another cell, an ultrasonic bonding apparatus applies vibration to the electrode tabs. At this time, the electrode tabs receive stress. This may make it difficult to obtain a reliable bonding strength of the electrode tabs. For example, at a time of ultrasonic bonding of the electrode tabs, to-be-bonded portions of the respective electrode tabs are gripped between a horn and an anvil of the ultrasonic bonding apparatus. In this condition, a phenomenon occurs in which a material part of each electrode tab, which ranges from the to-be-bonded portion to an end portion of the electrode tab, is swung about its to-be-bonded portion constrained between the anvil and horn. As a result, a crack due to fatigue may be generated at the boundary of the to-be-bonded portion.

In the ultrasonic bonding structure of PTL 1, the electrode tab has a bend shaped portion. This is for absorbing stress. For example, the bend shaped portion is provided in a top plate which is made from an aluminium plate. In this manner, prevention of generation of a crack is attempted in a structure having an aluminium plate with a thickness of 0.4 mm and a copper plate with a thickness of 0.2 mm stacked one on the other.

The battery pack is required, for example, to be able to supply an increased current to a motor or the like, and to be able to continue electric power supply for a prolonged period. In other words, the battery pack is required to have an increased capacity. To address the requirement for an increased capacity of the battery pack, the capacity of a cell constituting the battery pack tends to increase. The increase in the capacity of the cell requires that an allowable current of an electrode tab be increased, the electrode tab conducting a current supplied from the cell. In this respect, however, increasing the width of the electrode tab is restricted by the width of the cell itself. It therefore is conceivable to increase the thickness of the electrode tab in order to increase the allowable current of the electrode tab.

A bonding structure based on the technique of PTL 1 may face difficulties in obtaining a reliable bonding strength when the thickness of an aluminium plate serving as the electrode tab is more than 0.4 mm. A thickness more than 0.4 mm provides a high rigidity of the electrode tab, and thus decreases the ability to absorb stress in the bend shaped portion. Moreover, the bend shaped portion structurally tends to be subjected to concentrated stress. It therefore is likely that a fracture is generated in the bend shaped portion of the electrode tab.

An object of the present teaching is to provide a battery module that has a reliable bonding strength and that is capable of continuously outputting a large current.

### Solution to Problem

To solve the problems described above, the present teaching adopts the following configurations.

An accumulator module according to one embodiment includes at least two stacked accumulator cell bodies. An aluminium positive electrode terminal protrudes, without forming any step, from inside of one accumulator cell body out of the at least two accumulator cell bodies in a direction crossing the stacking direction, the aluminium positive electrode terminal having a plate-like shape with a thickness of more than 0.4 mm and not more than 1 mm in the stacking direction. A high-hardness negative electrode terminal has an overlap with the aluminium positive electrode terminal when viewed in the stacking direction and that protrudes, without forming any step, from inside of an accumulator cell body overlaid on the one accumulator cell body in the stacking direction, the high-hardness negative electrode terminal having a plate-like shape made of a conductive material with a hardness higher than that of aluminium. The accumulator module includes an ultrasonic pressure-welded portion formed by welding the aluminium positive electrode terminal that protrudes without forming any step and the high-hardness negative electrode terminal protruding without forming any step to each other in a region overlapping at least one ultrasonic pressure-welding horn impression when viewed in the stacking direction, the at least one ultrasonic pressure-welding horn impression being provided on a surface of the aluminium positive electrode terminal that protrudes without forming any step and that has a thickness of more than 0.4 mm and not more than 1 mm, the at least one ultrasonic pressure-welding horn impression being formed such that an entirety of the horn impression has its width in a width direction larger than its length in a protruding direction, the protruding direction being a direction in which the aluminium positive electrode terminal protrudes, the width direction being a direction crossing the protruding direction on a surface of the aluminium positive electrode terminal.

In the accumulator module, the aluminium positive electrode terminal has a thickness of more than 0.4 mm. This can deal with an increased capacity of the accumulator cell body. The accumulator module is able to continuously output a large current.

The plate-shaped aluminium positive electrode terminal protrudes from the accumulator cell body without forming any step. From the accumulator cell body that is overlaid thereon in the stacking direction, the plate-shaped high-hardness negative electrode terminal made of a conductive material with a hardness higher than that of aluminium protrudes without forming any step. The accumulator module includes the ultrasonic pressure-welded portion formed by welding the aluminium positive electrode terminal and the high-hardness negative electrode terminal to each other. The ultrasonic pressure-welded portion is normally formed by applying pressure-welding and ultrasonic vibration to at least a part of portions of the aluminium positive electrode terminal and of the high-hardness negative electrode terminal overlapping each other when viewed in the stacking direction. In ultrasonic pressure-welding, the aluminium positive electrode terminal and the high-hardness negative electrode terminal in an overlapping state are constrained between a horn and an anvil serving respectively as a resonator and a bearing jig of an ultrasonic pressure-welding apparatus. The horn applies ultrasonic vibration to the aluminium positive electrode terminal. A contact surface of the horn which is to be contacted by a pressure-welding object has fine projections. In the accumulator module, the aluminium positive electrode terminal has the ultrasonic pressure-welding horn impression. This horn impression can be formed by the horn being pressed against the aluminium positive electrode terminal. The ultrasonic pressure-welded portion is provided in a region overlapping the horn impression when viewed in the stacking direction.

In an ultrasonic pressure-welding step, the horn directly applies vibration to the aluminium positive electrode terminal. The aluminium positive electrode terminal with a thickness of more than 0.4 mm has a high rigidity. It therefore is firmly fixed to the accumulator cell body having a heavy weight. In addition, the aluminium positive electrode terminal with a thickness of more than 0.4 mm has a heavy weight. Thus, the aluminium positive electrode terminal is less likely to move in its entirely. The aluminium positive electrode terminal has a hardness lower than that of the high-hardness negative electrode terminal. That is, the aluminium positive electrode terminal is made of a material relatively softer than the high-hardness negative electrode terminal. Of the aluminium positive electrode terminal, therefore, a portion contacted by the projections of the horn is likely to suffer from local vibration because it directly receives vibration from the projections.

The aluminium positive electrode terminal is less likely to move in its entirely, and its portion contacted by the projections of the horn is likely to suffer from local vibration. Consequently, in the ultrasonic pressure-welding, the portion of the aluminium positive electrode terminal contacted by the projections of the horn is largely displaced relative to its surroundings. Accordingly, vibration energy of the horn reaches a contact portion between the terminals with a high efficiency.

Thus, a reliable pressure-welding strength is given to the ultrasonic pressure-welded portion.

The aluminium positive electrode terminal and the high-hardness negative electrode terminal protrude respectively from the two accumulator cell bodies without forming any step, and are joined to each other at the ultrasonic pressure-welded portion. Thus, the aluminium positive electrode terminal and the high-hardness negative electrode terminal protruding respectively from the accumulator cell bodies obliquely extend so as to approach each other toward the ultrasonic pressure-welded portion. The horn impression in its entirety has its width larger than its length in the protruding direction. Therefore, in a region where the ultrasonic pressure-welded portion is to be formed, the interval between the aluminium positive electrode terminal and the high-hardness negative electrode terminal exhibits a less location-dependent variation immediately before the aluminium positive electrode terminal and the high-hardness negative electrode terminal are interposed between the horn and the anvil in the ultrasonic pressure-welding process. Thus, in the region where the ultrasonic pressure-welded portion is to be formed, a distance over which the aluminium positive electrode terminal and the high-hardness negative electrode terminal are pushed and displaced by the horn and the anvil exhibits a less location-dependent variation. This can reduce occurrence of a situation in which damage such as a fracture is generated in the aluminium positive electrode terminal and in the high-hardness negative electrode terminal during ultrasonic pressure-welding. Accordingly, a reliable pressure-welding strength is given to the ultrasonic pressure-welded portion.

The width of the entirety of the horn impression on the aluminium positive electrode terminal corresponds to a length of an image of the at least one horn impression projected in the protruding direction. The length of the image of the at least one horn impression projected in the protruding direction is a length of an image of one horn impression projected to an imaginary plane orthogonal to the protruding direction. For example, in a case where individual projected images of a plurality of horn impressions are separate from one another, the sum of lengths of the individual projected images serves as a projected image length. For example, in a case where individual projected images of a plurality of horn impressions overlap one another, a length of the overlapping projected images serves as a projected image length. The length of the entirety of the horn impression on the aluminium positive electrode terminal corresponds to a length of an image of the at least one horn impression projected in the width direction. The length of the image of the at least one horn impression projected in the width direction is a length of an image of one horn impression projected to an imaginary plane orthogonal to the width direction. For example, in a case where individual projected images of a plurality of horn impressions are separate from one another, the sum of lengths of the individual projected images serves as a projected image length. For example, in a case where individual projected images of a plurality of horn impressions overlap one another, a length of the overlapping projected images serves as a projected image length.

The horn impression is an impression resulting from pressing with the horn of the ultrasonic pressure-welding apparatus. The contact surface of the horn of the ultrasonic pressure-welding apparatus comes into contact with a pressure-welding object. The contact surface of the horn has an array of fine projections. The horn impression is composed of an array of concavities formed by penetration of the projections. The shape of the horn impression is in contrast to the shape of an anvil impression which is composed of an array of convexities.

The high-hardness negative electrode terminal is made of a conductive material suitable for an electrical terminal of the accumulator cell body. A metal such as copper or nickel may be mentioned as one example of the material of the high-hardness negative electrode terminal having a higher hardness than that of aluminium.

The step in the configuration of the accumulator module will now be described. Each of the aluminium positive electrode terminal and the high-hardness negative electrode terminal extend from inside of the accumulator cell bodies, pass through openings disposed in peripheral portions of the accumulator cell bodies, and are exposed to outside of the accumulator cell bodies. Each of the aluminium positive electrode terminal and the high-hardness negative electrode terminal are joined to the peripheral portions of the accumulator cell bodies in the openings of the accumulator cell bodies. Thus, the openings of the accumulator cell bodies are sealed. Each of the aluminium positive electrode terminal and the high-hardness negative electrode terminal includes a sealing portion, a pressure-welded portion, and an intermediate portion, the sealing portion being joined to the peripheral portion of the accumulator cell body so as to seal the opening of the accumulator cell body, the pressure-welded portion having the ultrasonic pressure-welded portion formed therein, the intermediate portion being located between the sealing portion and the pressure-welded portion. The sealing portion, the intermediate portion, and the pressure-welded portion are arranged in this order from the accumulator cell body side, when viewed in the protruding direction L. A configuration in which the sealing portion, the intermediate portion, and the pressure-welded portion of the aluminium positive electrode terminal are at the same position (height) with respect to the stacking direction T (see FIG. 1) allows the aluminium positive electrode terminal to protrude without forming any step. Even when the sealing portion and the pressure-welded portion of the aluminium positive electrode terminal are at different positions (heights) with respect to the stacking direction T, a configuration in which the sealing portion and the intermediate portion form a continuous curved surface (curvature surface) or a continuous plane while the intermediate portion and the pressure-welded portion form a continuous curved surface (curvature surface) or a continuous plane allows the aluminium positive electrode terminal to protrude without forming any step. Even when the sealing portion and the pressure-welded portion of the aluminium positive electrode terminal extend in the protruding direction L and are at different positions (heights) with respect to the stacking direction T, a configuration in which the sealing portion and the pressure-welded portion extending in the protruding direction L with the intermediate portion interposed therebetween entirely form a continuous curved surface allows the aluminium positive electrode terminal to protrude without forming any step. A configuration in which the sealing portion and the intermediate portion of the aluminium positive electrode terminal are continuous with each other making substantially no angle while the intermediate portion and the pressure-welded portion are continuous with each other making substantially no angle also allows the aluminium positive electrode terminal to protrude without forming any step. A shape protruding without forming any step includes a shape having a smooth curved surface. A shape without any step includes, for example, a shape with no folding or bending along a line extending in the width direction W (see FIG. 1). A shape protruding without forming any step includes, for example, a shape with a curvature. The same descriptions as those for the aluminium positive electrode terminal are true for the high-hardness negative electrode terminal, too. In the configuration of the accumulator module, above, both the aluminium positive electrode terminal and the high-hardness negative electrode terminal protrude without forming any step. According to an embodiment of the invention, neither one of the aluminium positive electrode terminal or the high-hardness negative electrode terminal of the accumulator module has a step. In PTL 1 (Japanese Patent No. 4946098), a positive electrode terminal has a sealing portion, an intermediate portion, and a pressure-welded portion that are shaped into a crank shape as shown in FIG. 4 of PTL 1, for example. In PTL 1, the sealing portion and the intermediate portion do not form either a continuous curved surface (curvature surface) or a plane, but make an angle. In PTL 1, the intermediate portion and the pressure-welded portion do not form either a continuous curved surface (curvature surface) or a plane, but make an angle.

The present teaching can adopt the following configurations.

In the accumulator module, the at least one ultrasonic pressure-welding horn impression in its entirety may have a width equal to or more than ⅓ of a length of the aluminium positive electrode terminal in the width direction.

In one embodiment, the aluminium positive electrode terminal and the high-hardness negative electrode terminal are pressure-welded to each other over ⅓ or more of the length of the aluminium positive electrode terminal in the width direction. Accordingly, a reliable pressure-welding strength is given to the ultrasonic pressure-welded portion, and a sufficient electrical connection corresponding to the width of the terminals is reliably obtained.

According to one embodiment, the at least one horn impression comprises a plurality of horn impressions, and a length of each of the plurality of horn impressions in the protruding direction is smaller than a length of each of the plurality of horn impressions in the width direction.

According to one embodiment, the ultrasonic pressure-welded portion of the accumulator module can be formed by, for example, performing an ultrasonic pressure-welding process a plurality of times while sequentially displacing the aluminium positive electrode terminal and the high-hardness negative electrode terminal so as to change their portions interposed between the horn and the anvil. By performing the ultrasonic pressure-welding process once, one ultrasonic pressure-welding horn impression is formed. Each horn impression has its length in the protruding direction smaller than its length in the width direction. In each ultrasonic pressure-welding process, therefore, a distance over which the aluminium positive electrode terminal and the high-hardness negative electrode terminal are pushed and displaced by the horn and the anvil exhibits a less location-dependent variation. This can reduce occurrence of a situation in which damage such as a fracture is generated in the aluminium positive electrode terminal and in the high-hardness negative electrode terminal during ultrasonic pressure-welding.

According to one embodiment, the aluminium positive electrode terminal has a rigidity higher than a rigidity of the high-hardness negative electrode terminal.

The aluminium positive electrode terminal on which the horn impression is provided may have a rigidity higher than the rigidity of the high-hardness negative electrode terminal. This allows the aluminium positive electrode terminal to be fixed to the accumulator cell body with a strong fixing force. As a result, a portion contacted by the projections of the horn is more largely displaced relative to a portion not contacted by the projections. Accordingly, a more reliable pressure-welding strength is given to the ultrasonic pressure-welded portion.

The aluminium positive electrode terminal may have a thickness larger than a thickness of the high-hardness negative electrode terminal.

In the accumulator module, the horn that applies vibration may be pressed not against the high-hardness negative electrode terminal which is relatively thin but against the aluminium positive electrode terminal which is thick, in the ultrasonic pressure-welding process. The thick aluminium positive electrode terminal in its entirety has a larger inertia than the thin high-hardness negative electrode terminal does. This causes a portion of the terminal contacted by the projections of the horn to be more largely displaced relative to a portion not contacted by the projections. Accordingly, a more reliable pressure-welding strength is given to the ultrasonic pressure-welded portion.

The high-hardness negative electrode terminal may have a larger curvature as compared to the aluminium positive electrode terminal.

The high-hardness negative electrode terminal which is thinner than the aluminium positive electrode terminal may have a larger curvature as compared to the aluminium positive electrode terminal, which means that the aluminium positive electrode terminal has a less curvature. Thus, less mechanical stress is generated in the aluminium positive electrode terminal which is relatively thick. Accordingly, a more reliable pressure-welding strength is given to the ultrasonic pressure-welded portion.

A distal end of the aluminium positive electrode terminal protruding from the accumulator cell body may protrude beyond a distal end of the high-hardness negative electrode terminal that is in contact with the aluminium positive electrode terminal.

The distal end of the aluminium positive electrode terminal may protrude beyond the distal end of the high-hardness negative electrode terminal, and therefore a larger curvature of the high-hardness negative electrode terminal is reliably obtained. As a result, less mechanical stress is generated in the aluminium positive electrode terminal which is relatively thicker. Accordingly, a more reliable pressure-welding strength is given to the ultrasonic pressure-welded portion.

### Advantageous Effects of Invention

The accumulator module according to the present teaching has a reliable pressure-welding strength, and is capable of continuously outputting a large current.

### BRIEF DESCRIPTION OF DRAWINGS

FIG. 1 is a perspective view of an accumulator module according to an embodiment of the present teaching.

FIG. 2 is a side view of the accumulator module shown in FIG. 1.

FIG. 3 is an enlarged view of a part of the accumulator module shown in FIG. 1.

FIG. 4 is a top view of a part of the accumulator module shown in FIG. 1.

FIG. 5A is a cross-sectional view of a part of the accumulator module as taken along the line 5-5 in FIG. 4.

FIG. 5B is a cross-sectional view of the part of the accumulator module.

FIG. 6 is a simplified diagram for explanation of an ultrasonic pressure-welding step in which ultrasonic pressure-welded portions are formed.

### DESCRIPTION OF EMBODIMENTS

The following will describe a preferred embodiment of the present teaching with reference to the drawings.

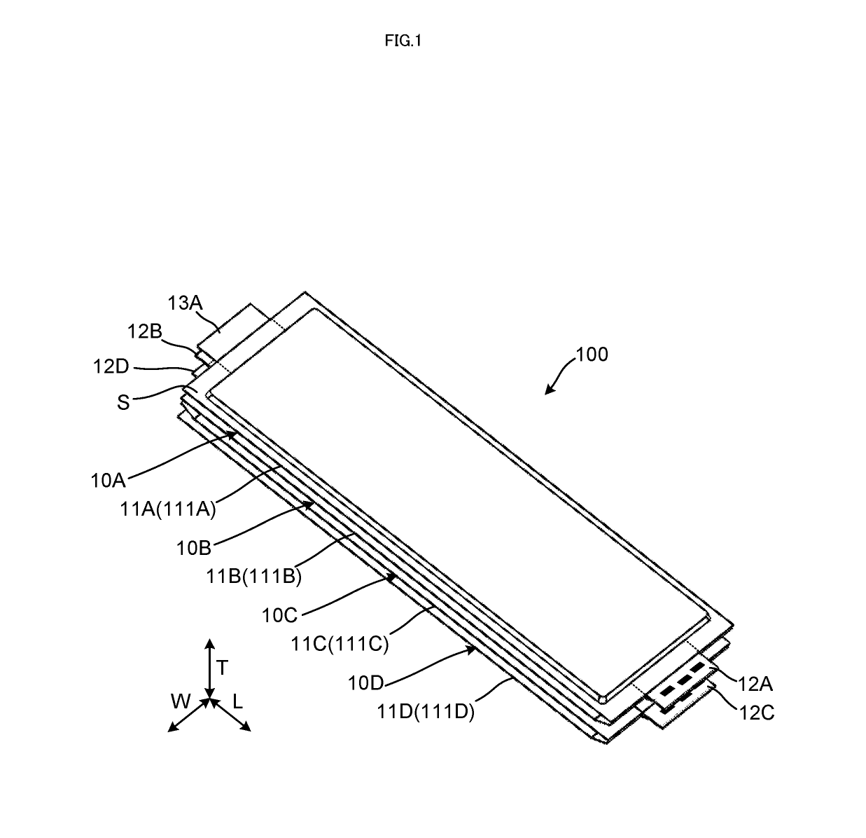

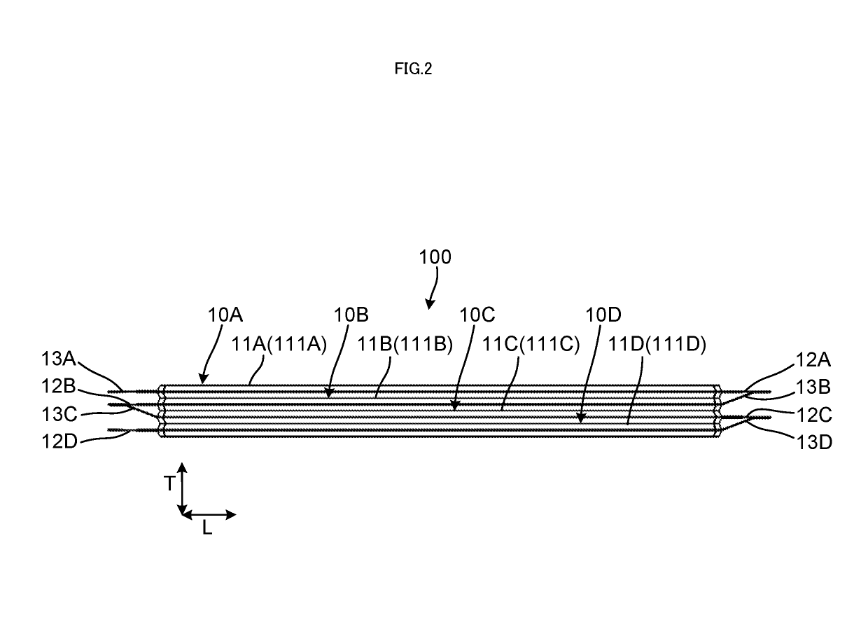

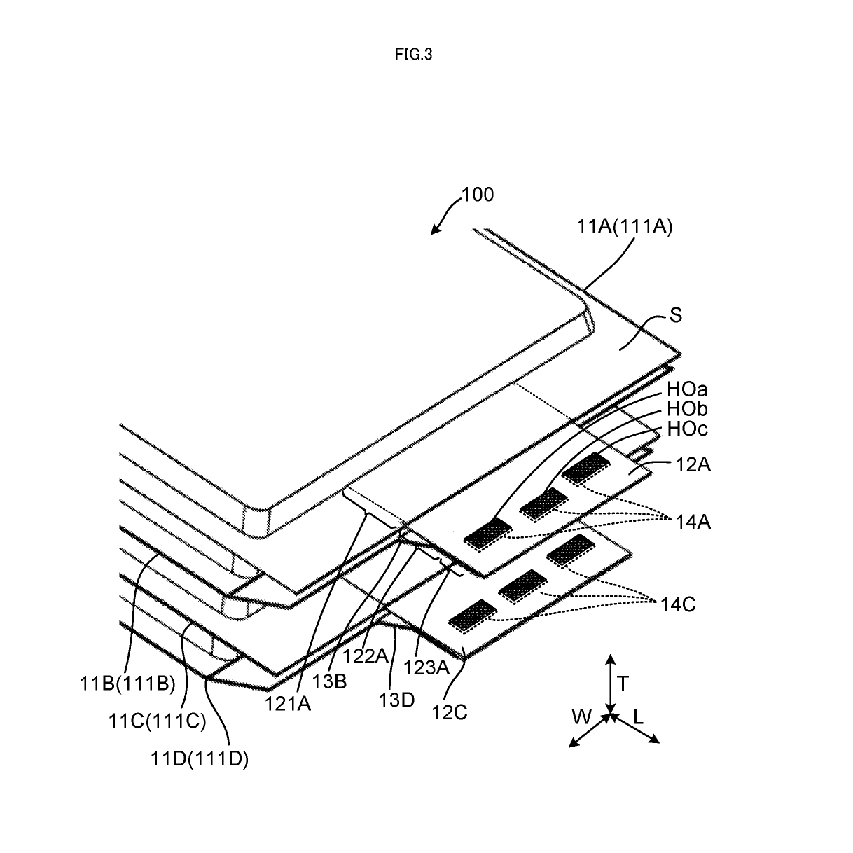

FIG. 1 is a perspective view of an accumulator module according to an embodiment of the present teaching. FIG. 2 is a side view of the accumulator module shown in FIG. 1. FIG. 3 is an enlarged view of a part of the accumulator module shown in FIG. 1.

An accumulator module 100 shown in FIG. 1 includes four accumulator cells 10A, 10B, 10C, 10D. The four accumulator cells 10A to 10D have identical configurations to one another. Each of the accumulator cells 10A to 10D is in the shape of a flat plate. The four accumulator cells 10A to 10D are stacked. A direction in which the accumulator cells 10A to 10D are stacked will be referred to as stacking direction T. It may be acceptable that a member different from an accumulator cell, such as a heat dissipation plate, is provided between ones of the four accumulator cells 10A to 10D.

The accumulator cells 10A, 10B, 10C, 10D include accumulator cell bodies 11A, 11B, 11C, 11D, aluminium positive electrode terminals 12A, 12B, 12C, 12D, and high-hardness negative electrode terminals 13A, 13B, 13C, 13D, respectively. The four accumulator cells 10A to 10D are electrically connected in series. In a plan view of the accumulator module 100, a direction in which the aluminium positive electrode terminal 12A and the high-hardness negative electrode terminal 13A protrude will be referred to as protruding direction L. A direction crossing the protruding direction L on the aluminium positive electrode terminal 12A will be referred to as width direction W.

The four accumulator cells 10A to 10D are stacked in the stacking direction T such that positions of the aluminium positive electrode terminals 12A to 12D and positions of the high-hardness negative electrode terminals 13A to 13D alternate with respect to the protruding direction L. Ultrasonic pressure-welded portions 14A are disposed between the aluminium positive electrode terminal 12A of the accumulator cell 10A and the high-hardness negative electrode terminal 13B of the accumulator cell 10B which is overlaid on the accumulator cell 10A in the stacking direction T. Ultrasonic pressure-welded portions 14B are disposed between the aluminium positive electrode terminal 12B and the high-hardness negative electrode terminal 13C. Ultrasonic pressure-welded portions 14C are disposed between the aluminium positive electrode terminal 12C and the high-hardness negative electrode terminal 13D. Out of the three kinds of ultrasonic pressure-welded portions 14A, 14B, 14C, only two kinds of ultrasonic pressure-welded portions 14A, 14C are shown in FIG. 3.

The accumulator module 100 shown in FIG. 1 includes the accumulator cell bodies 11A to 11D, the aluminium positive electrode terminals 12A, 12B, 12C, 12D, the high-hardness negative electrode terminals 13A, 13B, 13C, 13D, and the ultrasonic pressure-welded portions 14A, 14B, 14C.

The accumulator module 100 is an accumulator module for driving a vehicle. The accumulator module 100, however, is applicable to an apparatus other than vehicles. In an example, the accumulator module 100 is mounted on an apparatus such as a vehicle, and functions as an electric power supply. In an example, the accumulator module 100 is stored in a casing (not shown), and constitutes an accumulator pack. The accumulator module 100 is capable of continuously outputting a current of 100 A or more. The accumulator module 100 is capable of continuously outputting a current of 100 A or more for 15 minutes or longer, for example. A period for which the continuous output from the accumulator module 100 is allowed may be shorter than 15 minutes. The maximum current that can be continuously outputted from the accumulator module 100 may be less than 100 A.

Elements of the accumulator cell 10A will be described. The other accumulator cells 10B to 10D have configurations identical to that of the accumulator cell 10A.

The accumulator cell body 11A is in the shape of a flat plate. The accumulator cell body 11A is provided therein with a positive electrode, a negative electrode, and a separator, all of which are not shown. The positive electrode, negative electrode, and separator are stored in a sheet-shaped storage member 111A having a flexibility. The storage member 111A may be made from, for example, a resin-laminated metal foil. The positive electrode, negative electrode, and separator (not shown) are stacked in the stacking direction T within the storage member 111A.

The aluminium positive electrode terminal 12A and the high-hardness negative electrode terminal 13A extend from inside of the accumulator cell body 11A, pass through openings disposed in a peripheral portion S of the accumulator cell body 11A, and are exposed to outside of the accumulator cell body 11A. The aluminium positive electrode terminal 12A and the high-hardness negative electrode terminal 13A are joined to the peripheral portion S of the accumulator cell body 11A in the openings of the accumulator cell body 11A. Thus, the openings of the accumulator cell body 11A are sealed.

The aluminium positive electrode terminal 12A is a plate-shaped member made of aluminium. The aluminium positive electrode terminal 12A protrudes from inside of the accumulator cell body 11A. The aluminium positive electrode terminal 12A protrudes from the accumulator cell body 11A without forming any step. In the present specification and claims, not forming any step means extending from a first point (adjacent to the accumulator cell body 11A) to a second point (distal from the accumulator cell body 11A) that is at a different height in the stacking direction T without an angular corner, or with a curved shape. The aluminium positive electrode terminal 12A is a positive electrode terminal of the accumulator cell 10A. The aluminium positive electrode terminal 12A is electrically connected to a positive electrode (not shown) within the accumulator cell body 11A. The aluminium positive electrode terminal 12A has such a thickness that a current of 100 A or more can be continuously conducted. The thickness of the aluminium positive electrode terminal 12A in the stacking direction T is more than 0.4 mm and not more than 1 mm. The thickness of the aluminium positive electrode terminal 12A is preferably 0.5 mm or more and 1 mm or less, in view of allowing some margin for 100 A-current specifications.

The high-hardness negative electrode terminal 13A is a plate-shaped member. The high-hardness negative electrode terminal 13A is a member made of a conductive material having a hardness higher than that of aluminium. The high-hardness negative electrode terminal 13A is a member made of copper, for example. The high-hardness negative electrode terminal 13A has a plated surface. The high-hardness negative electrode terminal 13A may not be plated, however. The high-hardness negative electrode terminal 13A protrudes from inside of the accumulator cell body 11A. The high-hardness negative electrode terminal 13A protrudes from the accumulator cell body 11A without forming any step. In this embodiment, an orientation of the protrusion of the high-hardness negative electrode terminal 13A is opposite to an orientation of the protrusion of the aluminium positive electrode terminal 12A from inside of the accumulator cell body 11A. The high-hardness negative electrode terminal 13A is a negative electrode terminal of the accumulator cell 10A. The high-hardness negative electrode terminal 13A is electrically connected to a negative electrode (not shown) within the accumulator cell body 11A.

The thickness of the high-hardness negative electrode terminal 13A in the stacking direction T is smaller than the thickness of the aluminium positive electrode terminal 12A. Since copper has an electrical conductivity higher than that of aluminium, the magnitude of a current allowed by the high-hardness negative electrode terminal 13A can be comparable to the magnitude of a current allowed by the aluminium positive electrode terminal 12A.

The thickness of the high-hardness negative electrode terminal 13A in the stacking direction T is, for example, more than 0.24 mm and not more than 0.6 mm, considering that it is applied to such specifications that a current of 100 A can be continuously conducted. The thickness of the high-hardness negative electrode terminal 13A is preferably 0.3 mm or more and 0.6 mm or less, in view of allowing some margin for a current of 100 A or more. In this embodiment, the thickness of the high-hardness negative electrode terminal 13A is smaller than the thickness of the aluminium positive electrode terminal 12A, and therefore the high-hardness negative electrode terminal 13A has a flexural rigidity lower than that of the aluminium positive electrode terminal 12A.

The four accumulator cells 10A to 10D are stacked in the stacking direction T with the aluminium positive electrode terminal 12A and the high-hardness negative electrode terminal 13A arranged alternately with respect to the protruding direction L. For example, the aluminium positive electrode terminal 12A protruding from one accumulator cell body 11A out of the four accumulator cell bodies 11A to 11D and the high-hardness negative electrode terminal 13B protruding from the accumulator cell body 11B overlaid on the one accumulator cell body 11A have an overlap when viewed in the stacking direction T. In this embodiment, the aluminium positive electrode terminal 12A and the high-hardness negative electrode terminal 13B overlap each other when viewed in the stacking direction T.

The aluminium positive electrode terminal 12A and the high-hardness negative electrode terminal 13B extend in such a manner that they are closer to each other at a location farther from the accumulator cell bodies 11A, 11B in the protruding direction L.

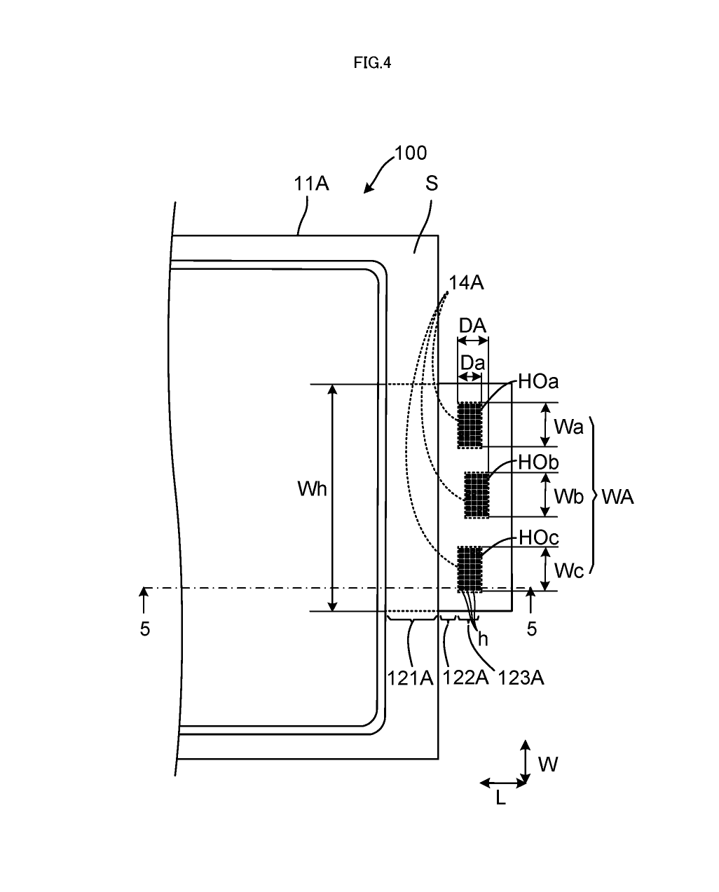

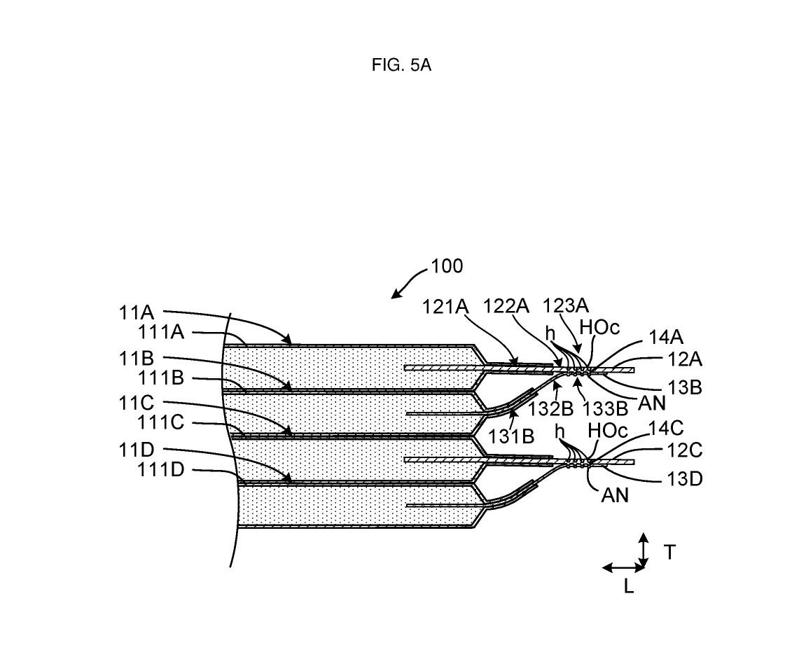

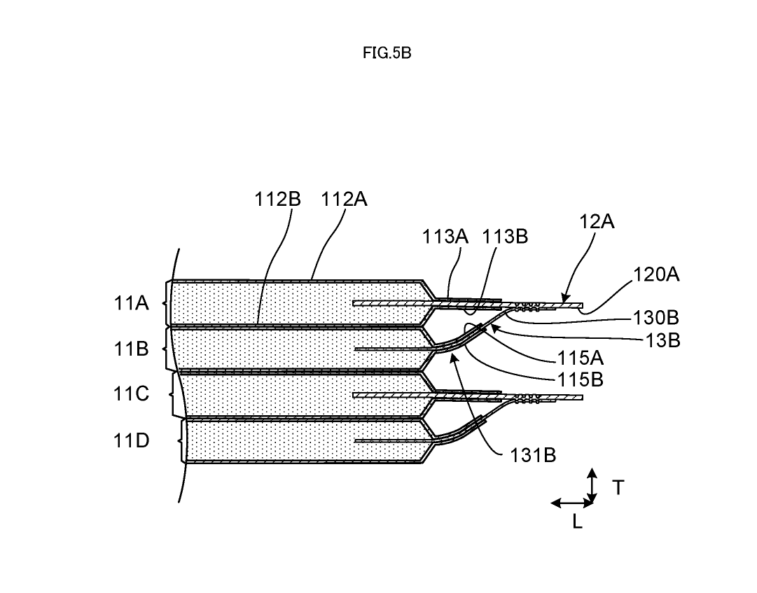

FIG. 4 is a top view of a part of the accumulator module 100 shown in FIG. 1. FIGS. 5A and 5B are cross-sectional views of a part of the accumulator module 100 as taken along the line 5-5 in FIG. 4. In FIGS. 5A and 5B, the interior structures of the accumulator cell body are not shown.

The ultrasonic pressure-welded portions 14A are disposed in a contact portion between the aluminium positive electrode terminal 12A and the high-hardness negative electrode terminal 13B. The ultrasonic pressure-welded portions 14A are formed by the aluminium positive electrode terminal 12A and the high-hardness negative electrode terminal 13B welded to each other. The ultrasonic pressure-welded portions 14A are formed through ultrasonic pressure-welding.

The aluminium positive electrode terminal 12A has three ultrasonic pressure-welding horn impressions HOa, HOb, HOc. It suffices that the number of ultrasonic pressure-welding horn impressions is at least one, and no particular limitation is put thereon. As shown in FIG. 4, the ultrasonic pressure-welded portions 14A are disposed in a region overlapping the ultrasonic pressure-welding horn impressions HOa, HOb, HOc when viewed in the stacking direction T. The aluminium positive electrode terminal 12A and the high-hardness negative electrode terminal 13B are joined to each other at the ultrasonic pressure-welded portions 14A. The aluminium positive electrode terminal 12A and the high-hardness negative electrode terminal 13B are electrically connected to each other at the ultrasonic pressure-welded portions 14A.

The aluminium positive electrode terminal 12A includes a sealing portion 121A, an intermediate portion 122A, and a pressure-welded portion 123A. The sealing portion 121A is a portion joined to the peripheral portion S of the accumulator cell body 11A so as to seal the opening of the accumulator cell body 11A. The pressure-welded portion 123A is a portion where the ultrasonic pressure-welded portions 14A are disposed. The intermediate portion 122A is a portion located between the sealing portion 121A and the pressure-welded portion 123A. The aluminium positive electrode terminal 12A protrudes from the accumulator cell body 11A without forming any step. The sealing portion 121A and the intermediate portion 122A form a continuous curved surface (curvature surface). The intermediate portion 122A and the pressure-welded portion 123A form a continuous curved surface (curvature surface). The sealing portion 121A and the intermediate portion 122A are continuous with each other making substantially no angle. The intermediate portion 122A and the pressure-welded portion 123A are continuous with each other making substantially no angle. The aluminium positive electrode terminal 12A has no fold. The aluminium positive electrode terminal 12A has not experienced any bending process.

The high-hardness negative electrode terminal 13B as well as the aluminium positive electrode terminal 12A includes a sealing portion 131B, an intermediate portion 132B, and a pressure-welded portion 133B. The high-hardness negative electrode terminal 13B protrudes from the accumulator cell body 11B without forming any step. The sealing portion 131B and the intermediate portion 132B form a continuous curved surface (curvature surface). The intermediate portion 132B and the pressure-welded portion 133B form a continuous curved surface (curvature surface). The sealing portion 131B and the intermediate portion 132B are continuous with each other making substantially no angle. The intermediate portion 132B and the pressure-welded portion 133B are continuous with each other making substantially no angle. The high-hardness negative electrode terminal 13B has no fold. The high-hardness negative electrode terminal 13B has not experienced any bending process.

As shown in FIG. 5B, the accumulator cell body 11A, includes an upper surface 112A and a lower surface 112B, and a conductive lead 120A of the aluminium positive electrode terminal 12A protrudes from the upper surface 112A and the lower surface 112B. Similarly, a conductive lead 130B of the high-hardness negative electrode terminal 13B protrudes from the upper surface 115A and the lower surface 115B, where the upper surface 115A and the lower surface 115B define the sealing portion 131B of the high-hardness negative electrode terminal 13B. In one embodiment, the portion of the high-hardness negative electrode terminal 13B corresponding to the sealing portion 131B is bent upward toward the conductive lead 120A of the aluminium positive electrode terminal 12A, without a step, or in other words without a sharp corner shape. A portion of the high-hardness negative electrode terminal 13B between the bent portion and the aluminium positive electrode terminal 12A includes a portion where the conductive lead 130B protrudes from the sealing portion 131B.

The pressure-welded portion 133B is formed on a distal end of the high-hardness negative electrode 13B from the sealing portion 131B. In embodiments of the present disclosure, the high-hardness negative electrode terminal 13B does not include a step or sharp corner, or in other words a corner where two straight portions meet at an angle, which may be an acute angle of less than sixty degrees, by way of example. In one embodiment, the portion of the high-hardness negative electrode 13B in the sealing portion 131B bends in a round arc-shape toward the aluminium positive electrode terminal 12A. In embodiments of the present disclosure, the rounded-corner shape or arc-shape is formed in the sealing portion 131B of the high-hardness negative electrode 13B. In some embodiments, the rounded or arc-shaped portion that causes the high-hardness negative electrode terminal 13B to bend upward toward the aluminium positive electrode terminal 12A is limited to the sealing portion 131B and does not extend into a portion of the high-hardness negative electrode 13B in which the conductive lead 130B extends from the sealing portion 131B.

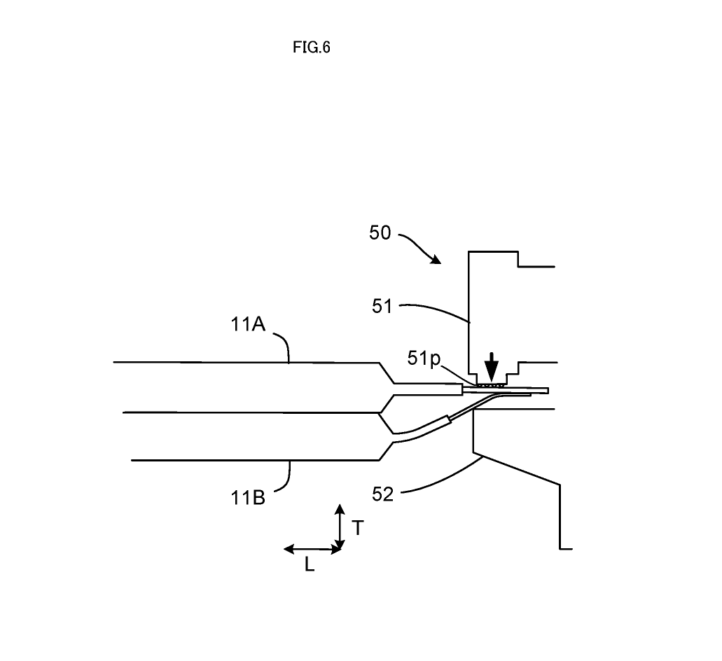

Each of the horn impressions HOa, HOb, HOc is an array of conical holes h. To be exact, the hole h has a truncated conical shape. A cross-sectional shape of the horn impression is not particularly limited. The horn impression is constituted of an array of concavities, for example. The array of conical holes h is one example of the array of concavities. The hole h having a truncated conical shape is one example of the concavity. The horn impressions HOa, HOb, HOc have the same shape. Each of the horn impressions HOa, HOb, HOc is formed by impression of a horn 51 of an ultrasonic pressure-welding apparatus (see FIG. 6). Each of the horn impressions HOa, HOb, HOc has its length Wa in the width direction W larger than its length Da in the protruding direction L.

The three horn impressions HOa, HOb, HOc are formed such that an entirety of three horn impressions HOa, HOb, HOc has its length WA in the width direction W larger than its length DA in the protruding direction L.

The length WA in the width direction W of the entirety of horn impressions HOa, HOb, HOc of the aluminium positive electrode terminal 12A corresponds to a length of an image of the three horn impressions HOa, HOb, HOc projected in the protruding direction L. In this embodiment, individual images of the three horn impressions HOa, HOb, HOc projected in the protruding direction L are separate from one another. The sum of lengths Wa, Wb, We of the individual projected images of the horn impressions HOa, HOb, HOc serves as the length WA in the width direction W, which means a width WA, of a projected image of the entirety of horn impressions HOa, HOb, HOc.

The length DA in the protruding direction L of the entirety of three horn impressions HOa, HOb, HOc corresponds to a length of an image of the horn impressions HOa, HOb, HOc projected in the width direction W. Individual images of the three horn impressions HOa, HOb, HOc projected in the width direction W overlap one another. A length of the overlapping projected images serves as the length DA of the entirety of horn impressions HOa, HOb, HOc in the protruding direction L.

The length DA of the entirety of three horn impressions HOa, HOb, HOc in the protruding direction L is smaller than the length WA thereof in the width direction W.

The length WA in the width direction W, which means the width WA, of the entirety of three horn impressions HOa, HOb, HOc is equal to or more than ⅓ of a length Wh of the aluminium positive electrode terminal 12A in the width direction W. In other words, the aluminium positive electrode terminal 12A and the high-hardness negative electrode terminal 13B are welded to each other over ⅓ or more of the length Wh in the width direction W.

The high-hardness negative electrode terminal 13A has ultrasonic pressure-welding anvil impressions AN (see FIG. 5) disposed at positions corresponding to the three horn impressions HOa, HOb, HOc. The anvil impression AN is an array of convexities corresponding to the holes h constituting each of the horn impressions HOa, HOb, HOc.

The ultrasonic pressure-welded portions 14A shown in FIG. 4 and FIG. 5 are formed by applying pressure-welding and ultrasonic vibration to at least a part of portions of the aluminium positive electrode terminal 12A and of the high-hardness negative electrode terminal 13A overlapping each other when viewed in the stacking direction T.

FIG. 6 is a simplified diagram for explanation of an ultrasonic pressure-welding step in which the ultrasonic pressure-welded portions 14A are formed.

In the ultrasonic pressure-welding step, an ultrasonic pressure-welding apparatus 50 is used. The ultrasonic pressure-welding apparatus 50 includes the horn 51 and an anvil 52. The horn 51 functions as an ultrasonic vibration resonator. Projections 51p are arrayed on a contact surface of the horn 51 which is to be contacted by a pressure-welding object. Each of the projections 51p has a conical shape. To be exact, each of the projections 51p has a truncated conical shape. The anvil 52 functions as a bearing jig. A contact surface of the anvil 52 which is to be contacted by a pressure-welding object has grooves disposed at positions corresponding to the projections 51p of the horn 51.

The aluminium positive electrode terminal 12A and the high-hardness negative electrode terminal 13A in an overlapping state are interposed between the horn 51 and the anvil 52. Before being interposed between the horn 51 and the anvil 52, the aluminium positive electrode terminal 12A and the high-hardness negative electrode terminal 13A have no step formed thereon, and have no bending process performed thereon, for example. The aluminium positive electrode terminal 12A and the high-hardness negative electrode terminal 13A are pressure-welded by the horn 51 and the anvil 52. The horn 51 directly applies vibration to the aluminium positive electrode terminal 12A. Of the aluminium positive electrode terminal 12A, at least a portion contacted by the projections 51p are especially subjected to strong vibration.

The aluminium positive electrode terminal 12A to which pressure-welding and vibration are applied is welded to the high-hardness negative electrode terminal 13A. As a result, the horn impressions HOa, HOb, HOc are formed in the aluminium positive electrode terminal 12A. The ultrasonic pressure-welded portions 14A are formed at positions overlapping the horn impressions HOa, HOb, HOc in the stacking direction T.

In this embodiment, the aluminium positive electrode terminal 12A has the three horn impressions HOa, HOb, HOc. Such a configuration is achieved by interposing the aluminium positive electrode terminal 12A and the high-hardness negative electrode terminal 13A between the horn 51 and the anvil 52 three times while changing their positions in each of the three times.

The hardness of the aluminium positive electrode terminal 12A is lower than the hardness of the high-hardness negative electrode terminal 13A. The thickness of the aluminium positive electrode terminal 12A is larger than the thickness of the high-hardness negative electrode terminal 13A. The aluminium positive electrode terminal 12A has a thickness of more than 0.4 mm in order to allow continuous conduction of a large current. Thus, the rigidity of the aluminium positive electrode terminal 12A is higher than the rigidity of the high-hardness negative electrode terminal 13A. Since the aluminium positive electrode terminal 12A has a high rigidity, it is firmly fixed to the accumulator cell body 11A which has a heavy weight. The aluminium positive electrode terminal 12A with a thickness of more than 0.4 mm has a heavy weight, and therefore it has a large inertia. This is why the aluminium positive electrode terminal 12A is less likely to move in its entirety even when vibration is applied thereto, as compared to an aluminium positive electrode terminal with a thickness of 0.4 mm or less, for example.

Meanwhile, the aluminium positive electrode terminal 12A is made of a material softer than the high-hardness negative electrode terminal 13B. Of the aluminium positive electrode terminal 12A, therefore, the portion contacted by the projections 51p of the horn 51 is likely to suffer from local vibration because it directly receives vibration from the projections 51p.

The aluminium positive electrode terminal 12A is less likely to move in its entirely, and its portion contacted by the projections 51p of the horn 51 is likely to suffer from local vibration. Consequently, in the ultrasonic pressure-welding, the portion of the aluminium positive electrode terminal 12A contacted by the projections 51p of the horn 51 is largely displaced relative to its surroundings. Accordingly, vibration energy of the horn 51 reaches the contact portion between the terminals 12A, 13B with a high efficiency. In addition, the aluminium positive electrode terminal 12A has a thickness of more than 0.4 mm. Of the aluminium positive electrode terminal 12A, therefore, a portion pushed by the projections 51p of the horn 51 in a squeezing manner has a thickness sufficient to provide a reliable bonding strength. Thus, the aluminium positive electrode terminal 12A bites into the high-hardness negative electrode terminal 13A while maintaining a sufficient thickness. The aluminium positive electrode terminal 12A has a thickness of 1 mm or less. This allows vibration received from the projections 51p to efficiently transfer to the contact portion with the high-hardness negative electrode terminal 13A. Consequently, the aluminium positive electrode terminal 12A and the high-hardness negative electrode terminal 13A are more firmly welded. Thus, a reliable pressure-welding strength is given to the ultrasonic pressure-welded portions 14A (see FIG. 5).

The aluminium positive electrode terminal 12A and the high-hardness negative electrode terminal 13B protrude respectively from the two accumulator cell bodies 11A, 11B without forming any step, and are joined to each other at the ultrasonic pressure-welded portions 14A (see FIG. 5). Thus, the aluminium positive electrode terminal 12A and the high-hardness negative electrode terminal 13B protruding respectively from the accumulator cell bodies 11A, 11B extend in such a manner that they are closer to each other at a location farther from the accumulator cell bodies 11A, 11B. As shown in FIG. 4, the entirety of horn impressions HOa, HOb, HOc has its length WA in the width direction W larger than its length DA in the protruding direction L. Therefore, the interval between the aluminium positive electrode terminal 12A and the high-hardness negative electrode terminal 13B exhibits a less location-dependent variation while the aluminium positive electrode terminal 12A and the high-hardness negative electrode terminal 13B are interposed between the horn 51 and the anvil 52 as shown in FIG. 6. The location-dependent variation is especially small in the protruding direction L. Thus, in a region where the ultrasonic pressure-welded portions 14A (see FIG. 5) are to be formed, a distance over which the aluminium positive electrode terminal 12A and the high-hardness negative electrode terminal 13B are pushed and displaced by the horn 51 and the anvil 52 exhibits a less location-dependent variation. This enables the aluminium positive electrode terminal 12A and the high-hardness negative electrode terminal 13B to be deformed merely by a small amount in a period from when the aluminium positive electrode terminal 12A and the high-hardness negative electrode terminal 13B come into contact with the horn 51 and the anvil 52 to when constraint with the horn 51 and the anvil 52 is completed.

Each of the horn impressions HOa, HOb, HOc has its length Da in the protruding direction L smaller than its length Wa, Wb, We in the width direction W. In each ultrasonic pressure-welding process, therefore, a distance over which the aluminium positive electrode terminal 12A and the high-hardness negative electrode terminal 13B are pushed and displaced by the horn 51 and the anvil 52 exhibits a small location-dependent variation.

This can reduce occurrence of a situation in which damage such as a fracture is generated in the aluminium positive electrode terminal 12A and in the high-hardness negative electrode terminal 13B during ultrasonic pressure-welding. In addition, during pressure-welding of the aluminium positive electrode terminal 12A and the high-hardness negative electrode terminal 13B, a pressure variation is less likely to occur in pressure-welded surfaces of the aluminium positive electrode terminal 12A and of the high-hardness negative electrode terminal 13B. Especially, a pressure variation in the pressure-welded surfaces is less likely to occur in the protruding direction L. This gives an increased uniformity to the pressure-welding strength of the ultrasonic pressure-welded portions 14A in its entirety. Thus, a reliable pressure-welding strength is given to the ultrasonic pressure-welded portions 14A (see FIG. 5).

The aluminium positive electrode terminal 12A and the high-hardness negative electrode terminal 13B protrude respectively from the two accumulator cell bodies 11A, 11B, without forming any step. It therefore is less likely that, for example, when the horn 51 applies vibration to the aluminium positive electrode terminal 12A which has a high rigidity, stress of the vibration concentrates on a particular portion. Thus, occurrence of a situation in which the aluminium positive electrode terminal 12A is damaged is reduced. This can reliably give a good contact between the aluminium positive electrode terminal 12A and the high-hardness negative electrode terminal 13B.

In the accumulator module 100 of this embodiment, the high-hardness negative electrode terminal 13B has a larger curvature than that of the aluminium positive electrode terminal 12A, as shown in FIG. 5. A distal end of the aluminium positive electrode terminal 12A protrudes beyond a distal end of the high-hardness negative electrode terminal 13B. In this way, a larger curvature of the high-hardness negative electrode terminal 13B is reliably provided. Thus, reduced mechanical stress is generated in the aluminium positive electrode terminal 12A which is thicker than the high-hardness negative electrode terminal 13B. Consequently, a more reliable pressure-welding strength is given to the ultrasonic pressure-welded portions 14A.

As shown in FIG. 4, the aluminium positive electrode terminal 12A and the high-hardness negative electrode terminal 13B are pressure-welded to each other over ⅓ or more of the length Wh of the aluminium positive electrode terminal 12A in the width direction. Accordingly, a reliable pressure-welding strength is given to the entirety of the ultrasonic pressure-welded portions 14A which overlap the horn impressions HOa, HOb, HOc, and a sufficient electrical connection corresponding to the width Wh of the terminals 12A, 13B is reliably obtained.

The aluminium positive electrode terminal 12A, the high-hardness negative electrode terminal 13A, and the ultrasonic pressure-welded portions 14A have been described above. The above descriptions are also true for the other aluminium positive electrode terminals 12B, 12C, the other high-hardness negative electrode terminals 13C, 13D, and the other ultrasonic pressure-welded portions 14B, 14C.

The embodiment described above deals with an exemplary accumulator module including four accumulator cells 10A to 10D. Here, the number of accumulator cells included in the accumulator module just needs to be at least two.

The configuration of the accumulator module according to the present teaching is not limited to a configuration in which the distal end of the aluminium positive electrode terminal protrudes beyond the distal end of the high-hardness negative electrode terminal. For example, it may be acceptable that the distal end of the high-hardness negative electrode terminal protrudes beyond the distal end of the aluminium positive electrode terminal. In the accumulator module according to the present teaching, the high-hardness negative electrode terminal may not always need to have a larger curvature than that of the aluminium positive electrode terminal. For example, it may be acceptable that the aluminium positive electrode terminal has a larger curvature than that of the high-hardness negative electrode terminal.

In the accumulator module according to the present teaching, the thickness of the aluminium positive electrode terminal may be smaller than the thickness of the high-hardness negative electrode terminal. For example, in a case where nickel is employed as a material of the high-hardness negative electrode terminal, the thickness of the aluminium positive electrode terminal is set smaller than the thickness of the high-hardness negative electrode terminal under the condition that an allowable current magnitude is the same. In this case, the rigidity of the aluminium positive electrode terminal may be lower than the rigidity of the high-hardness negative electrode terminal.

The embodiment described above illustrates an example of the accumulator cells 10A to 10D from which the high-hardness negative electrode terminal 13A and the aluminium positive electrode terminal 12A protrude in opposite directions. The high-hardness negative electrode terminal and the aluminium positive electrode terminal are not limited to this, and for example, they may protrude beside each other in the same direction from the same side of the accumulator cell.

In the accumulator module according to the present teaching, each horn impression may have its length in the protruding direction larger than its length in the width direction. Arranging a larger number of such horn impressions in the width direction, for example, enables an entirety of the horn impressions to occupy ⅓ or more of the length of the aluminium positive electrode terminal in the width direction.

In the accumulator module according to the present teaching, an entirety of horn impressions may occupy less than ⅓ of the length of the aluminium positive electrode terminal in the width direction. It however is preferable that an entirety of horn impressions occupies ½ or more of the length of the aluminium positive electrode terminal in the width direction, in view of a current allowable in the ultrasonic pressure-welded portion.

It should be understood that the terms and expressions used in the above embodiments are for descriptions and not to be construed in a limited manner, do not eliminate any equivalents of features shown and mentioned herein, and allow various modifications falling within the claimed scope of the present teaching. The present teaching may be embodied in many different forms. The present disclosure is to be considered as providing embodiments of the principles of the teaching. The embodiments are described herein with the understanding that such embodiments are not intended to limit the teaching to preferred embodiments described herein and/or illustrated herein. The embodiments described herein are not limiting. The present teaching includes any and all embodiments having equivalent elements, modifications, omissions, combinations, adaptations and/or alterations as would be appreciated by those in the art based on the present disclosure. The limitations in the claims are to be interpreted broadly based on the language employed in the claims and not limited to embodiments described in the present specification or during the prosecution of the present application. The present teaching is to be interpreted broadly based on the language employed in the claims.

### REFERENCE SIGNS LIST

100 accumulator module
10A, 10B, 10C, 10D accumulator cell
11A, 11B, 11C, 11D accumulator cell body
12A, 12B, 12C, 12D aluminium positive electrode terminal
13A, 13B, 13C, 13D high-hardness negative electrode terminal
14A, 14B, 14C ultrasonic pressure-welded portion
111A, 111B, 111C, 111D storage member
HOa, HOb, HOc horn impression
L protruding direction
T stacking direction
W width direction

1. An accumulator module comprising:
at least two accumulator cell bodies, one of the at least two accumulator cell bodies stacked on another of the at least two accumulator cell bodies;
an aluminium positive electrode terminal that protrudes, without forming any step, from inside the one accumulator cell body in a direction crossing a stacking direction, the aluminium positive electrode terminal having a plate-like shape with a thickness of more than 0.4 mm and not more than 1 mm in the stacking direction;
a high-hardness negative electrode terminal that has an overlap with the aluminium positive electrode terminal when viewed in the stacking direction and that protrudes, with a bend and without forming any step, from inside the another accumulator cell body, the high-hardness negative electrode terminal having a plate-like shape made of a conductive material with a hardness higher than that of aluminium; and
an ultrasonic pressure-welded portion formed by welding the aluminium positive electrode terminal and the high-hardness negative electrode terminal protruding to each other in a region overlapping at least one ultrasonic pressure-welding horn impression when viewed in the stacking direction, the at least one ultrasonic pressure-welding horn impression being provided on a surface of the aluminium positive electrode terminal that has a thickness of more than 0.4 mm and not more than 1 mm, the at least one ultrasonic pressure-welding horn impression being formed such that an entirety of the horn impression has its width in a width direction larger than its length in a protruding direction, the protruding direction being a direction in which the aluminium positive electrode terminal protrudes, the width direction being a direction crossing the protruding direction on a surface of the aluminium positive electrode terminal.

2. The accumulator module according to claim 1, wherein
the at least one ultrasonic pressure-welding horn impression has a width equal to or more than ⅓ of a length of the aluminium positive electrode terminal in the width direction.

3. The accumulator module according to claim 1, wherein
the at least one horn impression comprises a plurality of horn impressions, and
a length of each of the plurality of horn impressions in the protruding direction is smaller than a length of each of the plurality of horn impressions in the width direction.

4. The accumulator module according to claim 1, wherein
the aluminium positive electrode terminal has a rigidity higher than a rigidity of the high-hardness negative electrode terminal.

5. The accumulator module according to claim 1, wherein
the aluminium positive electrode terminal has a thickness greater than a thickness of the high-hardness negative electrode terminal.

6. The accumulator module according to claim 5, wherein
the high-hardness negative electrode terminal has a larger curvature than the aluminium positive electrode terminal.

7. The accumulator module according to claim 6, wherein
a distal end of the aluminium positive electrode terminal protruding from the accumulator cell body protrudes beyond a distal end of the high-hardness negative electrode terminal that is in contact with the aluminium positive electrode terminal.
